(19) United States
(12) Patent Application Publication
(10) Pub. No.: US 2012/0296702 A1
(43) Pub. Date: Nov. 22, 2012

(54) ASSET MARKETING NETWORK BUSINESS METHOD AND MACHINE FOR USE IN CONDUCTING THE SAME

(76) Inventors: John P. Fontana, Scottsdale, AZ (US); Gary A. Mestman, Scottsdale, AZ (US)

(21) Appl. No.: 13/473,374

(22) Filed: May 16, 2012

Related U.S. Application Data
(60) Provisional application No. 61/486,497, filed on May 16, 2011.

(51) Int. Cl. G06Q 30/06; G06Q 30/02

(52) U.S. Cl. 705/7.35; 705/26.43

(57) ABSTRACT

A method of conducting an asset marketing network business, and a machine for conducting the same, is disclosed, which includes the steps of hosting an asset marketing network website and registering asset marketing network members, including asset posting member and asset buying members, where asset marketing network members are allowed access to the asset marketing network website. The machine stores data associated with an asset, including controlled asset posting data and uncontrolled asset posting data. The machine can be used to allow the asset buying member access to the controlled asset posting data, in response to receiving approval from the asset posting member to allow the asset buying member access to the controlled asset posting data. The machine can be used to store and release prequalification data associated with the asset buying member.

### CROSS REFERENCE TO RELATED APPLICATION

This application claims priority to U.S. Provisional patent application to John P. Fontana et al, entitled “Asset Marketing Network Business Method and Machine For Use in Conducting the Same,” Ser. No. 61/486,497, filed May 16, 2011, the disclosure of which is hereby incorporated entirely herein by reference.

### BACKGROUND OF THE INVENTION

1. Technical Field

This invention relates generally to the buying and selling of assets and in particular to a method of conducting an asset marketing network business and a machine for use in conducting an asset marketing network business.

2. State of the Art

There exists a very active market for the buying and selling of assets worldwide. For high-value assets and other items not sold through a retail store, brokers are often used to connect buyers and sellers of assets. In the real estate market in the United States and worldwide, for example, real estate brokers are used to facilitate real estate sales. Similarly, when buying or selling a business, a piece of fine art, or other high-value assets, a broker has often been used as the go-between to connect a buyer to a seller and to facilitate the purchase transaction. The asset broker earns money by using their personal knowledge and contacts to find a buyer for an asset seller, and to lead the seller and/or the buyer through the purchasing process. The prevalent use of computers and the internet has made this type of system, a system that relies on personal contacts and knowledge, out-dated and expensive. Continuing with the real estate example, for instance, real estate brokers are often paid 5% to 7% or more of the purchase price for their services. This cost is paid by the buyer of the real estate, and is then passed along to the next buyer. The result is a system which has increased the cost of real estate an unsustainable amount.

A real estate broker's value includes a network of contacts that can be used to find a buyer for a particular real property, as well as their knowledge of the forms and legal process for completing the real estate sale. Today, however, computer networks can provide a potential network for a seller that is much larger than any one person can provide. Buyers and sellers of high-value assets still need a process and a method to buy and sell assets, but it should be less expensive and less dependent on a third-party individual, such as a broker, facilitating the process. Thus it is desirable to have a asset marketing network business method for facilitating the sale of high-value assets, that is not based on a personal network of contacts and information, and a machine for use in conducting an asset marketing network business that allows sellers to connect with buyers and facilitates the purchase process with a minimum of cost and involvement of a third-party individual such as a broker.

### DISCLOSURE OF THE INVENTION

The present invention relates generally to the buying and selling of assets and in particular to a method of conducting an asset marketing network business and a machine for use in conducting an asset marketing business.

A method of conducting an asset marketing network business is disclosed which includes the steps of hosting an asset marketing network website and registering asset marketing network members, wherein asset marketing network members are allowed access to the asset marketing network website. The method of conducting an asset marketing network business also includes the steps of allowing asset marketing network members access to asset marketing network website utilities according to membership type, and receiving fees from asset marketing network members. In some embodiments the step of registering asset marketing network members, wherein asset marketing network members are allowed access to the asset marketing network website includes the step of registering an asset marketing network asset buying member, where the asset buying member is allowed access to the asset marketing network website. In some embodiments the step of registering asset marketing network members, wherein asset marketing network members are allowed access to the asset marketing network website includes the step of registering an asset marketing network asset posting member, where the asset posting member is allowed access to the asset marketing network website.

In some embodiments of the method of conducting an asset marketing network business, the step of allowing asset marketing network members access to asset marketing network website utilities according to membership type includes the step of obtaining a set of asset posting information/data from the asset posting member, wherein the set of asset posting information pertains to an asset. In some embodiments the set of asset posting information includes controlled asset posting information and uncontrolled asset posting information. In some embodiments the set of asset posting information is stored in an asset database. In some embodiments the step of allowing asset marketing network members access to asset marketing network website utilities according to membership type includes the step of allowing the asset buying member to use an asset search utility of the asset marketing network website to search the asset database. In some embodiments of the method of conducting an asset marketing network business, the step of allowing asset marketing network members access to asset marketing network website utilities according to membership type includes the step of transferring controlled asset posting information between the asset buying member and the asset posting member in response to receiving an approval from both the asset buying member and the asset posting member to transfer the controlled asset posting information. In some embodiments the step of receiving fees from asset marketing network members includes receiving an asset success fee in response to the asset buying member purchasing the asset.

A method of conducting an asset marketing network business is disclosed which includes the step of registering an asset marketing network asset buying member, where the asset buying member is allowed access to an asset marketing network website, and the step of registering an asset marketing network asset posting member, where the asset posting member is allowed access to the asset marketing network website. The method of conducting an asset marketing network according to the invention also includes the step of obtaining a set of asset posting information from the asset posting member, wherein the set of asset posting information pertains to an asset, and the step of allowing the asset buying member to use an asset search utility of the asset marketing network website to search an asset database. In some embodiments the set of asset posting information includes controlled asset posting information and uncontrolled asset posting information. In some embodiments the set of asset posting information is stored in the asset database. The method of conducting an asset marketing network according to the invention also includes the step of transferring controlled asset posting information between the asset buying member and the asset posting member in response to receiving an approval from both the asset buying member and the asset posting member to transfer the controlled asset posting information, and the step of receiving an asset purchase fee in response to the asset buying member purchasing the asset.

A machine for use in conducting an asset marketing network business is disclosed which includes a memory with an executable software program stored on the memory, and a microprocessor in electrical communication with the memory. The software program instructs the microprocessor to perform a set of steps which includes the step of storing a set of asset posting data/information in an asset search database, wherein the set of asset posting information pertains to an asset and wherein the asset posting information is assigned to an asset posting member, and the step of allowing an asset marketing network asset buying member to search the asset search database. In some embodiments the set of asset posting information includes controlled asset posting information and uncontrolled asset posting information. The set of steps the software program instructs the microprocessor to perform also includes the steps of providing the set of uncontrolled asset posting information to the asset buying member in response to an indication of interest in the asset from the asset buying member, and the step of releasing the set of controlled asset posting information to the asset buying member in response to receiving an indication of approval to release the set of controlled asset posting information from both the asset posting member and the asset buying member.

Disclosed is a machine for conducting an asset marketing network business. The machine includes a microprocessor coupled to a memory configured to perform a number of steps. The steps the microprocessor is configured to perform includes the step of storing asset posting data, where the asset posting data pertains to an asset. The asset posting data is assigned to an asset posting member. The asset posting data includes uncontrolled asset posting information and controlled asset posting information. The steps the microprocessor is configured to perform also includes the step of storing an indication that the asset buying member requests access to the controlled asset posting information. The steps the microprocessor is configured to perform also includes the step of storing an indication that the asset posting member approves the asset buying member receiving access to the controlled asset posting information. And the steps the microprocessor is configured to perform includes the step of allowing the asset buying member access to the controlled asset posting information in response to receiving the indication from the asset posting member of approval for allowing the asset buying member access to the controlled asset posting information.

In some embodiments the microprocessor is configured to perform the step of calculating a current market value for the asset. In some embodiments the step of calculating a current market value for the asset comprises the step of storing a property address for the asset. In some embodiments the step of calculating a current market value for the asset comprises the step of searching the internet to find sales data for a set of similar properties in a predetermined geographical area near the asset. In some embodiments the step of calculating a current market value for the asset comprises the step of storing a property condition rating for the asset. In some embodiments the step of calculating a current market value for the asset comprises the step of calculating a current market value for the asset, based on the property condition rating and the sales data for the set of similar properties in the predetermined geographical area near the asset. In some embodiments the microprocessor coupled to the memory is further configured to perform the steps of storing prequalification data associated with the asset buying member, and restricting the asset posting member from accessing the prequalification data. In some embodiments the microprocessor coupled to the memory is further configured to perform the step of storing an indication that the asset posting member requests access to the prequalification data. In some embodiments the microprocessor coupled to the memory is further configured to perform the step of storing an indication that the asset buying member approves of the asset posting member receiving access to the prequalification data. In some embodiments the microprocessor coupled to the memory is further configured to perform the step of allowing the asset posting member access to the prequalification data in response to receiving the indication that the asset buying member approves of the asset posting member receiving access to the prequalification data. In some embodiments the prequalification data comprises a prequalification statement from a lender. In some embodiments the prequalification data comprises a statement of sufficient funds from a bank.

Disclosed is a microprocessor coupled to a memory configured to perform the steps of hosting an asset marketing network website, registering, via the website, an asset posting member, receiving from the asset posting member, via the website, a set of controlled asset posting data pertaining to an asset, and registering, via the website, a plurality of asset buying members. The microprocessor coupled to a memory is also configured to perform the steps of blocking each of the plurality of asset buying members from accessing, via the website, the set of controlled asset posting data, receiving, via the website, a request from a specific asset buying member for access to the set of controlled asset posting data, sending a request, via the website, to the asset posting member for an indication of whether the specific buying member should be allowed access to the set of controlled asset posting data, and allowing access, via the website, to the set of controlled asset posting data by the specific buying member in response to receiving an indication from the asset posting member approving the specific buying member receiving access to the set of controlled asset posting data. In some embodiments the microprocessor is configured to perform the step of calculating a current market value for the asset. In some embodiments the microprocessor is configured to perform the step of calculating an amount of funds the specific asset buying member can finance. In some embodiments the microprocessor is configured to perform the step of providing to the asset posting member, via the website, the amount of funds the specific asset buying member can finance. In some embodiments the microprocessor is configured to perform the step of providing to the specific buying member, via the website, a set of asset purchase forms customized to follow laws governing the sale of the asset.

Disclosed is a computer performed method of conducting an asset marketing network website business. The computer performed method of conducting an asset marketing network business includes the steps of using the computer to host an asset marketing network website, and receiving, via the website, a set of controlled asset posting data pertaining to an asset, wherein the controlled asset posting data is associated with an asset posting member. The computer performed method of conducting an asset marketing network business includes the steps of blocking access via the website to the controlled asset posting data by an asset buying member, and receiving a request, via the website, for the asset buying member to receive access to the controlled asset posting data. The computer performed method of conducting an asset marketing network business also includes the steps of allowing the asset buying member access, via the website, to the controlled asset posting data in response to receiving approval, via the website, that the asset posting member approves providing the asset buying member access to the controlled asset posting data, and receiving a fee from the asset posting member in response to the asset buying member purchasing the asset.

In some embodiments the method also includes the steps of registering an asset posting member, where the asset posting member is allowed access to the asset marketing network website, and registering an asset buying member, wherein the asset buying member is allowed access to the asset marketing network website. In some embodiments the method also includes the steps of receiving, via the website, a set of uncontrolled asset posting data from the asset posting member, where the set of uncontrolled asset posting data pertains to the asset, storing the set of uncontrolled asset posting data in a database, and allowing the asset buying member access, via the website, to the set of uncontrolled asset posting data. In some embodiments the step of receiving, via the website, a set of uncontrolled asset posting data from the asset posting member includes the steps of computing a current market value for the asset; providing, via the website, a list of asset inspectors; and providing, via the website, a list of asset appraisers. In some embodiments the step of receiving, via the website, a set of uncontrolled asset posting data from the asset posting member includes the steps of providing, via the website, a list of vendors of advertising services, and receiving from the asset posting member, via the website, an advertisement for the asset.

In some embodiments the method of conducting an asset marketing network website business also includes the steps of receiving, via the website, a set of prequalifying data from the asset buying member; allowing web access to the set of prequalifying data by the asset posting member in response to receiving a request, via the website, that the asset buying member requests access to the controlled asset posting data; and receiving approval, via the website, that the asset posting member approves of providing the asset buying member access to the set of controlled asset posting data. In some embodiments the step of receiving, via the website, a set of prequalifying data from the asset buying member includes the steps of providing to the asset buying member, via the website, a listing of lending institutions, computing a monthly payment amount, providing to the asset buying member, via the website, a set of prequalification forms, and receiving, via the website, the set of prequalifying data from the asset buying member.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 shows method 100 which is one embodiment of conducting an asset marketing network business according to the invention.

FIG. 2 shows machine 110 for use in conducting the asset marketing network business according to the invention. Machine 110 is used to host the asset marketing network website that is used in the asset marketing network business.

FIG. 3 shows an example embodiment of machine 110 according to the invention, which in this embodiment is included in server 118 and accessed by user interface device 124 via internet connection 122.

FIG. 4 shows method 200, another embodiment of conducting an asset marketing network business according to the invention.

FIG. 5 shows set of steps 300 according to the invention that microprocessor 116 coupled to memory 112 is configured to perform according to the invention.

FIG. 6 shows set of steps 400 that microprocessor 116 coupled to memory 112 according to the invention is configured to perform.

FIG. 7 shows set of steps 500 that machine 110 according to the invention performs.

FIG. 8 shows method 600 of conducting an asset marketing network website business according to the invention.

### DETAILED DESCRIPTION OF EMBODIMENTS OF THE INVENTION

As discussed above, embodiments of the present invention relate generally to buying and selling assets and in particular to a method of conducting an asset marketing network business and a machine for use in conducting an asset marketing network business. The asset marketing network business facilitates the buying and selling of any type of asset, but particularly assets such as real estate, businesses, and other valuable assets.

For valuable assets and other items not sold through a retail store, brokers are often used to connect the buyer and the seller of an asset. In the real estate market, for example, real estate brokers are used to facilitate sales. Similarly, when buying or selling a business, a piece of fine art, or other valuable assets, a broker has often been used as the go-between to connect a buyer to a seller and to facilitate the sale of the asset. The asset broker makes a living by using their personal knowledge and contacts to find a buyer for an asset seller, and to lead the seller and/or the buyer through the purchase process.

Computers and the internet have made the personal-broker-facilitated system that is built on personal contacts and knowledge, outdated and expensive. Continuing with the real estate example, for instance, real estate brokers are often paid 5% to 7% or more of the purchase price for their services. This fee is paid by the buyer of the real estate, and is then passed along to the next buyer. The result is a system which has increased the cost of real estate an unsustainable amount. A real estate broker's value includes a contact network that can find a buyer for a property, and their knowledge of the forms and legal process for completing the real estate sale. It used to be that this specialized knowledge and contact network justified the fees that real estate brokers charge. Today, however, computer networks can provide a potential network for a seller that is much larger than any one person can provide. In addition, the process, information and forms needed to complete a real estate transaction can be standardized, regionalized and organized better with a computer than by an individual.

Buyers and sellers of high-value assets still need a process and a method to buy and sell assets, but it should be less expensive and less dependent on a third-party individual, such as a broker, to facilitate the process. Thus it is desirable to have an asset marketing network business method for facilitating the sale of high-value assets, that is not based on a personal network of contacts and information, and a machine for use in conducting an asset marketing network business that allows sellers to connect with buyers, and facilitates the sales process with a minimum of cost and involvement of a third-party individual such as a broker. The knowledge, skills, and networking ability of an asset broker can be provided by a computerized system in a way that is much less costly to either the buyer or the seller, provides a system that give the seller access to a worldwide network of buyers, while still providing the guidance and specificity needed to complete a sale in a particular location and under specific local, national, and worldwide laws and regulations.

Described in this document is a method of conducting a business which includes creating an asset marketing network website. The asset marketing network website facilitates the creation of an asset marketing network designed to allow members of the asset marketing network to post for sale real estate, businesses, and other high value assets. The posting will be global, allowing asset marketing network buying members worldwide near instant access to information on the posted assets. The asset marketing network will provide the means and assistance, with little or no third party intervention, to connect buyers and sellers and complete a sales transaction.

The use of the asset marketing network and the asset marketing network website will be an advantage for a seller because they can use the knowledge and utilities available on the asset marketing network website to determine a fair price for their asset, to accurately describe their asset, post information about their asset into a searchable database, and to be connected with a large network of viable, pre-qualified buyers of their asset. The price of the asset will not include a large commission to a broker, allowing the seller to set their price lower than would be necessary if selling through a broker.

The use of the asset marketing network and the asset marketing network website will be an advantage for the buyer because they can use the knowledge and utilities available on the asset marketing network website to find the asset they are looking for at a fair price. The asset marketing network website will provide them the tools to search through a worldwide database of assets posted by other asset marketing network members. The asset marketing network website will provide the buyer's assistance needed to evaluate the asset, inspect the asset, and eventually purchase the asset. The asset buyer will be paying a fair price because a broker's commission will not be added to the cost of the asset.

The asset marketing network and the asset marketing network website will be an advantage for the asset marketing network business owner because it will allow them to earn a living by collecting fees earned through the use of the asset marketing network website. The asset marketing network business owner will be collecting a fee for each successful sale, for instance. The fees charged per sale will be much less than brokers charge, but the number of transactions will be larger and the amount of work the business owner invests in each transaction is lower. The asset marketing network business owner is the one who designs, hosts, and maintains the asset marketing network website. Once this initial investment is complete, however, the website can provide the assistance and guidance for each individual transaction instead of a person providing this guidance. The network will grow and survive with minimal personal interaction from the business owner, allowing individuals worldwide to interact and transact business relatively independently. The size and scope of the network will not be limited by the capabilities of an individual. The asset marketing network business owner will receive money not only from each transaction completed, but can collect fees from vendors who would like to sell their services on the network, from advertisers, and from brokers who may want to use the network to sell assets.

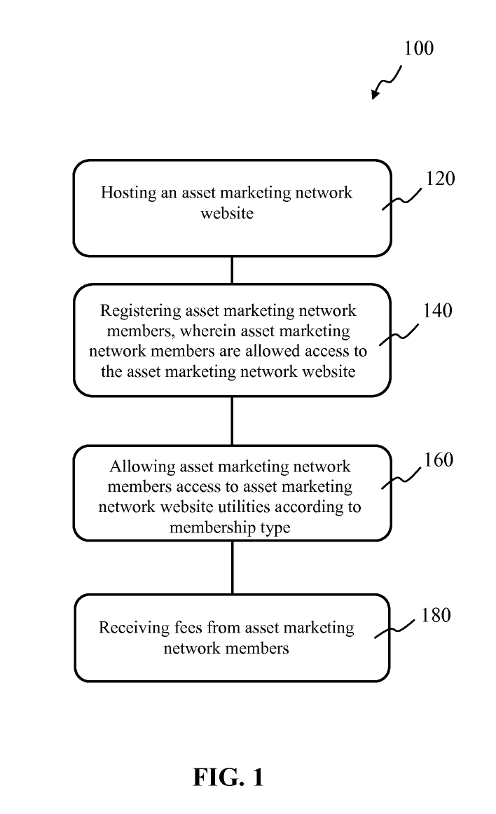

FIG. 1 shows a flow diagram of the basic steps of method 100, which is one embodiment of conducting an asset marketing network business according to the invention. Method 100 of conducting an asset marketing network business includes step 120, hosting an asset marketing network website, step 140, registering asset marketing network members, step 160, allowing asset marketing network members access to asset marketing network website utilities according to the membership type, and step 180 receiving fees from asset marketing network members. There can be many more steps in method 100.

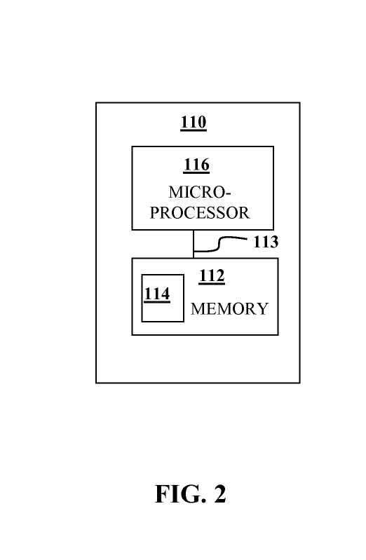

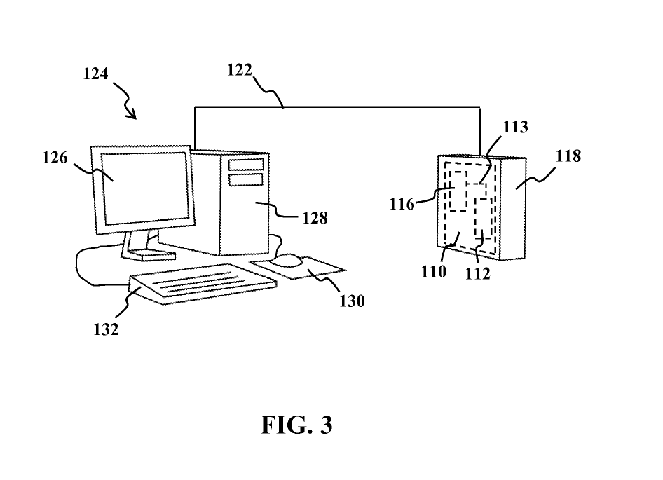

Step 120 of hosting an asset marketing network website includes all the steps involved in creating and offering for use to the public an asset marketing network website. FIG. 2 shows one embodiment of machine 110 according to the invention that is used to host an asset marketing network website. Machine 110 includes microprocessor 116 coupled to memory 112 by connection 113. Connection 113 can be any type of electrical coupling, wired or wireless. Memory 112 includes software program 114 which instructs microprocessor 116 to perform the steps involved in hosting the asset marketing network website. In this embodiment machine 110 is included in server 118 as shown in FIG. 3, where machine 110 is resident on server 118, which can be accessed by user interface devices 124 via internet connection 122. In some embodiments of the invention, machine 110 is part of a computer, such as a desktop, laptop, or other computing device. In some embodiment of the invention, machine 110 is part of a mobile computing device such as a personal digital assistant, a cellular telephone, a microcomputer, or other electronic device.

In the particular embodiment of machine 110 shown in FIG. 2 and FIG. 3, machine 110 including memory 112 and microprocessor 116 reside on server 118. Server 118 can be accessed using connection 122, which can be a wired connection, a wireless connection, or, as in this embodiment, an internet connection. Machine 110 is connected to interface device 124 via connection 122. Interface device 124 in this embodiment is a desktop computer which includes computer tower 128, monitor 126, keyboard 132, and mouse 130. Monitor 126, keyboard 132, and mouse 130 are connected to computer tower 128 in a manner well known in the art for home or office computers. Connection 122 in this embodiment is an internet connection which connects interface device 124 to server 118 as is well known in the art of internet computing, internet communication, and internet commerce.

Connection 122 can be many different types of electrical connections such as, for example but not by way of limitation, a wired local area network (LAN), a wireless local area network (WLAN), a Bluetooth connection, a cellular connection, a landline phone connection, an optical fiber connection, or any other communications or connection method available now or in the future.

Interface device 124 as shown in FIG. 3 is a desktop computer. In some embodiments interface device 124 is other types of computing or communication devices. Interface device 124 can be many different types, for example but not by way of limitation, a desktop computer, a laptop computer, a cellular phone, a smart phone, a personal digital assistant (PDA), an electronic reader, or a microcomputer. Interface device 124 can be any device that can interface with machine 110 for purposes related to conducting the asset marketing network business method according to the invention. There can be any number of user interface device 124 accessing machine 110, as is known in the art of internet connections and websites.

The asset marketing network website will be the home base for asset marketing network members. The asset marketing network website will be used by asset marketing network members to buy and sell assets. Asset marketing network members will be reliably connected securely and confidentially through the use of discrete ID numbers. Asset posting members are able to post assets for sale. Asset buying members are able to search the asset marketing network database of assets for sale. Asset buying members and asset posting members will have access to information, websites, and guides that help guide them through the purchase process.

Forms, information, and data that is specialized for a particular region, or a particular type of asset, will be available through the website. A glossary of terms will be available on the asset marketing network website that will define the terms used by the asset marketing network and by the asset marketing network website. Asset buying members will be able to pre-qualify for purchases through links to banks and lending institutions. The network will allow secure communication between members. Some asset information can be controlled by the asset posting member and only released to a specific asset buying member upon approval of the asset posting member. Buyer prequalification data can be controlled by the asset buying member and only released upon approval of the asset buying member. Certain asset posting information can be controlled by the asset posting member and not released to the buyer until the buyer is pre-qualified and the seller—the asset posting member—authorizes the information to be released.

The asset marketing network will provide access and/or links to all the necessary channels of information that may be of great value to both asset buying members and asset posting members, such as municipal data, homeowners association data, transportation, schools, hospitals, ad writers, asset inspectors, banks, title companies, and other vendors that may be needed or desired. The asset marketing network will provide links or access to forms needed in the sales process such as contracts, disclosures, inspections needed, etc. These forms will be regionally specific to allow the buying process to conform to all laws and regulations.

Once a contract has been accepted and signed by both the asset marketing network buying member and the asset marketing network asset posting members, the asset marketing network will provided the roadmap outlining the next items to be addressed, including, for example, termite inspections, systems inspections, property surveys, insurance history inspection, a review of the HOA documents, title search and final loan approval. All necessary documents to complete the contract and close escrow and take title will be available through the asset marketing network. Referrals to asset marketing network member professionals to complete the transaction will be available to asset marketing network members. In locations where an attorney is necessary, the asset marketing network will provide links to attorneys in the area. The asset marketing network member obtaining the services from the member professional will be responsible for paying to the member professional the cost of the services received.

The asset marketing network will provide links to connect asset marketing network members to many of the necessary vendors such as appraisers, lenders, attorneys, surveyors, home inspectors, other inspectors, and more. The asset marketing network member vendors advertise and offer all members a genuine discount from their standard pricing schedule. The asset marketing network also provides a connection to other vendors i.e. plumbers, electricians, general contractors, roofers, house painters, movers, decorators, and more, who must also be asset marketing network members and advertise and offer the asset marketing network member genuine discounts.

The network will connect asset marketing network asset buying members with asset marketing network asset selling (posting) members and provide a guide to a completed transaction. The path to the completed transaction will be accomplished by following an asset marketing network master checklist that regionally covers all aspects of the process.

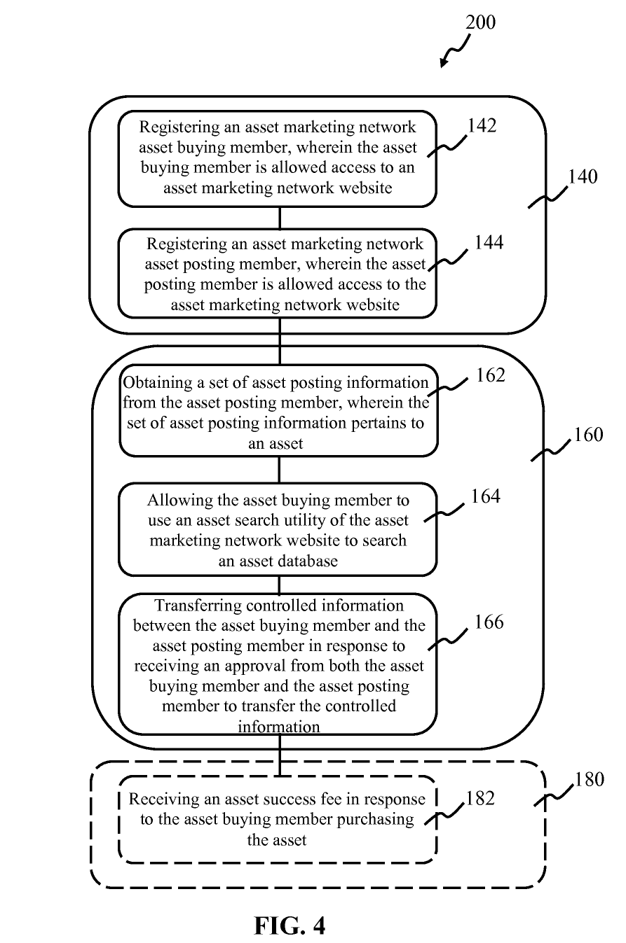

FIG. 4 shows method 200 of conducting an asset marketing business according to the invention. Method 200 provides further details of some of the steps in FIG. 1. Method 100 of FIG. 1 includes step 140, registering asset marketing network members, wherein asset marketing network members are allowed access to the asset marketing network website. To become an asset marketing network member, prospective members visit the asset marketing network website and proceed to follow the steps outlined on the website. Table 1 shows the steps involved in becoming an asset marketing network member. Asset marketing network members can choose which type of asset marketing network member they want to become. The basic types of memberships are the asset posting member, for members who want to sell assets, and the asset buying member, for asset marketing network members who want to buy assets. But there are many other types of memberships available, as shown in Table 2. Members can register to be multiple types of members. Some types of memberships will have fees associated with becoming that type of member, such as realtor members, home builder members, or other types of members who are marketing products or services. All asset marketing network member types are able to use the asset marketing network to search for available assets. Different types of software utilities, information, and capabilities will be available to specific member types through the asset marketing network website.

Method 200 of conducting an asset marketing network business according to the invention includes step 142, and step 144, as shown in FIG. 2. Step 142 and 144 are included in step 140 of FIG. 1. Step 142 according to the invention includes registering an asset marketing network asset buying member, wherein the asset buying member is allowed access to an asset marketing network website. Asset marketing network asset buying members are allowed access to specific asset marketing network website utilities that will guide and instruct them through the asset buying process, as explained below with respect to step 160.

Step 144 according to the invention includes registering an asset marketing network asset posting member, wherein the asset posting member is allowed access to the asset marketing network website. Asset marketing network asset posting members are allowed access to specific asset marketing network website utilities that will guide and instruct them through the asset posting process, as explained below with respect to step 160.

Step 140 of method 100 shown in FIG. 1 can include the step or steps involved in registering many other types of members, including but not limited to any of those types of members shown in Table 2.

TABLE 1
Joining the Asset Marketing Network

```
The Prospective Member visits the Asset Marketing Network Website to
become informed about the features and benefits of using the Network.
There is no cost to join the Network, it is “FREE”.
After this step:
An Icon appears: Click it.
Choose to:
    Join with all the benefits. Enter your email address.
  Do not join but receive updates. Enter you email address
Asset Marketing Network Membership Type is chosen at this time
(see Table 2):
There is never any purchase required by the Network!
Click: After selecting the option to join the Network . . .
An Icon appears: Click it.
The New Asset Marketing Network Member completes the necessary
informational application and is now a Member.
After becoming a Member a discrete ID number is assigned by the
Network and a password is created by the Member.
This number becomes the conduit through which all private and secure
communications and information are conveyed.
If the new Asset Posting Member is currently using a Realtor they may
choose to notify the Realtor of their decision to Post to the Network
and request a modification, renegotiate or cancel their agreement. Be
sure to have all correspondence in writing. Save the documents.
After this step:
An Icon appears: Click it.
All Asset Marketing Network Member types will be able to search all
Asset Marketing Network Postings.
The Asset Posting Members can now post their property to the Network
for the Asset Buying Members to view.
```

TABLE 2
Types of Asset Marketing Network Members

```
Asset Posting Membership.
    Posting personal residential property or other assets for sale to the
    Network, at no charge.
Asset Buying Membership.
    To review all Properties types, business opportunities and other
    assets for purchase, at no charge
Realtor Membership.
    Realtors are able to Post their listings to the Network for sale, Fee
    based per Posting.
Tract Home Builders Membership.
    Constructing New sub-divisions, Fee based on the size of the
    development.
Adult (over 55) Communities Membership.
    To Post residences for sale, fee based.
Adult (over 55) Communities for Membership.
    To Post residences for rent, fee based.
Assisted Living Community Membership.
    To Post for rent special residences, fee based.
Custom Home Building Membership.
    Building and designing custom homes on special sites. fee based.
Modular Home Builders Membership.
    Designing, Producing and selling factory built homes, fee based.
Mobile Home Builders Membership.
    Designing, building and selling mobile based self-contained homes,
    fee based.
Residential and Apartment rental and leasing Membership.
    For those companies and individuals that rent and lease personal
    residences, fee based.
Luxury Property Posting Membership.
    Posting for sale Super Luxury Estates and Villas world wide.
Vacation Property Posting Membership.
    Posting vacation properties for sale. Fee Based.
Vacation Property for Rent Membership.
    Posting vacation properties for short or long term rental, worldwide.
    Fee based.
Vacation and Property Exchange Membership.
    Posting exchange properties. one week to one year. Fee based.
Tenant in Common Membership
    To Post for sale Partial Ownership in residential property, fee based.
Time Share Property Posting Membership
    To Post for sale Time Shares world wide, fee based
Time Share Rental Membership.
    To Post for rent Time shares world wide, fee based. Not deed or
    ownership based!
Fractional Property Posting Membership.
    To Post for sale Fractional ownership properties, fee based.
    Deeded Ownership.
Fractional Property for Rent Posting Membership.
    To Post for rent Fractional ownership properties, fee based.
Business Posting Membership.
    To Post any type of Business for sale, by SIC code. The SIC code
    classifies defines the market segment of the Posted Business
National Advertising Membership.
    Nationally branded Companies that want to utilize the network to
    market their products and services, per click and fee based.
Regional Advertising Membership.
    Regionally branded Companies that want to utilize the Network to
    market their products and services, per click and fee based.
Local Advertising Membership.
    Locally branded Companies that want to utilize the Network to
    market their products and services, per click and fee based.
Professional Services Advertising Membership.
    Attorneys Accountants
    Surveyors
    Engineers
    Architects
Health related service provider Membership
    Banks
    Insurances Companies
    Brokerage Companies and any fee based providers.
Investment Opportunity Membership.
    All types of income producing property, Sale Lease Backs
    Triple Net Leases
    Commercial and Residential investments Tax Credits
Commercial Property Posting Membership.
    Posting all types of Shopping Centers and free standing buildings.
Industrial Property Posting Membership.
    Warehouses
    Office Warehouses
    Mini Storage Facilities
Office Buildings and Complexes
Leasing Membership
    All types of Commercial and Industrial properties.
Other Project Membership
    Vineyards
Properties for Rent or Sale in and near National Parks Membership.
    Amusement Parks, Zoos
    Hotels
    Inns
    B &B's
```

Method 100 of FIG. 1 includes step 160 allowing asset marketing network members access to asset marketing network website utilities according to membership type. Each member type is provided a path to achieving their goals. Asset posting members, for example, are provided the tools they need through the asset marketing network website to allow them to post their asset and to continue to a completed transaction. A member who wishes to sell a real property, for example, would be provided access to a property posting utility which would guide them through the asset marketing network property posting process. Table 3 lists the asset marketing network property posting process the asset posting member would be guided through. Table 4 shows a property posting master checklist which would be provided to each asset posting member when posting a real property for sale on the asset marketing network website. Table 5 shows an example list of possible types of property that can be listed on the asset marketing network website.

The asset marketing network property posting process will guide the asset posting member through a process which allows them to gather data about their property. This data will eventually be turned into a set of asset posting information pertaining to an asset, in this example a real property. Step 162 of FIG. 4, where step 162 is included in step 160 of FIG. 1, is the step of obtaining a set of asset posting information (data) from the asset posting member, where the set of asset posting information pertains to an asset. In some embodiments the asset posting data includes uncontrolled asset posting information and controlled asset posting information. In some embodiments step 162 includes the step of storing the set of asset posting information in a searchable asset database. The set of uncontrolled asset posting information is the information that other asset marketing network members can search through to find assets they are interested in purchasing. The controlled asset posting information can be released to specific asset buying member who are approved by the asset posting member to receive the controlled asset posting information. Step 162 can include many different types of steps depending on the type of asset that is to be sold. Continuing the example of real estate to be sold, Table 3 shows the steps that the asset posting member will be guided through by the asset marketing network website utilities to accomplish the step of gathering and posting a set of asset posting information on the real property they wish to sell.

Table 3 shows that the asset posting member will be guided in steps which will allow them to determine the current market value of the property. Links to local assessor's sites will be provided. Multiple Listing Service sites links will be provided so the asset posting member can find comparable sales and listings for a set of similar properties in a predetermined geographical area near the asset. Information on performing an inspection on their property, as well as links to member vendors who can perform inspection, are provided. The website can be used to obtain and store a property condition rating for the asset. The asset marketing website can be used to calculate the current market value of the asset based on the property condition rating and the sales data for the set of similar properties in the predetermined geographical area near the asset.

The asset posting member obtains assistance through the asset marketing network website for writing an ad, or receiving information on advertisement writing services that are available, as well as assistance in collecting and posting pictures and videos. The asset posting member is guided through entering, formatting, and storing this information on the asset marketing network website, and once it is complete, to posting this information so that is can be searched by all asset marketing network members. The asset posting member is provided data by the asset marketing network as to how many visits and clicks their set of asset posting information receives. Once a qualified asset buying member is found, the asset marketing network is guides both the asset buying member and the asset posting member through the process of completing the sale.

TABLE 3
Property Posting Process

Available to Asset Marketing Network Asset Posting Members
An Icon appears: Click it.
At this time the Asset Posting Master Checklist (See Table 4) appears with
steps for a Clear Path to a successful posting of their property. Print this
and use it to chart your progress.
After this step:
An Icon appears: Click
This icon will direct the Member to multiple links that will assist in
ascertaining a correct current market value of their property.
This information should be recorded in the space provided in the Master
Check List for future use.
After this step:
An Icon appears: Click it.
Providing links to the local Assessors website (if available in your area)
to search for all the recent transactions.
At this time you can locate your property on the database and extract all
the information available for you own use.
This search may have an impact on the Posting as the appraised value of
the posting should be used as a guide to determine the posting price.
After this step:
An Icon appears: Click it.
Providing links to the local Multiple Listing Services and any other
relevant Real Estate websites. This will assist Members in determining
comparable values in the Members geographical area.
After this step:
An Icon appears: Click it.
Recommending a Pre-Posting Home inspection to find and cure any faults
that may have a negative impact on the value of the posting.
When this option is selected:
An Icon appears: Click it.
Providing links to approved Member Home Inspection Companies that
will offer members a discount. After the inspection the Member can
now make a competent decision regarding a posting price.
After this step:
An Icon appears: Click it.
At this time a Posting Application appears where the member enters all the
asset posting information, which pertains to the asset being posted,
where indicated on the form describing the property as recommended.
Including the correct Posting Price as determined by the Network
Protocols and the Member good judgement.
It is recommended that all the following information be included on the
Posting Application:
City
Town
County
Village
State
Country
Utilities
Sewers/septic
Water/city/well
Telephone number with area code and/or country code.
Zip code
Postal code. Not U.S.
Sub Division
School district
Recreational facilities
Transportation facilities. Trains, buses, Major highways and other
significant arteries
Medical facilities
Places of Worship, Churches, Temples, Synagogues and more.
Shopping
Airports and Airport traffic areas
Environmental issues,
Adult Community over 55, 40
Family Community.
Pets
Horses
Use the additional notes section to add comments of importance.
This data is greatly expanded to enhance the Posting and Sale of the
property. See Table 5 for complete set of Types of posted property.
After this step
An Icon appears: Click it.
Virtual Ad Writer:
Member Professional ad writers are available to assist the Posting Member
to create a powerful Posting.
This is strictly an option and not required.
There is a fee for this service option.
After this step:
An Icon appears: Click it.
Photos Videos
When these boxes are checked photographs and videos of the Posting may
be uploaded.
The member may view our marketing suggestion page for assistance in
crafting their posting for maximum impact to the Buying Member.
Professional Photos or Videos:
When this box is checked, Members will be provided links to Member
Professional Photographers and Videographers.
The network stresses and recommends that quality photos and videos be
utilized to create a greater visual impact to the Buying Members. This is a
very effective tool for luxury properties
There is a fee for this service option.
After this step
An Icon appears: Click it.
At this point all factual data and information has been inputted to the Set
of Asset Posting information in the Application in a clear and concise
manner.
After a careful review of the Application, the Asset Posting Member clicks
the BOX to Send to Network.
The Asset Posting now goes global.
Asset Marketing Network Communications:
The Asset Marketing Network then confirms to the Asset Posting Member
via email that the Application has been accepted and Posted.
The Asset Posting Member will receive electronic notification DAILY of
all posting clicks and hits from the Asset Buying members.
The Asset Buying Member is asked to complete a Comment
Questionnaire which benefits the Asset Posting Member by providing
pertinent and essential remarks regarding their property.
All data, communications plus pertinent and related information will be
retained on the Network servers for access by the Asset Posting Member.
This information is emailed to the Asset Posting Member.
Congratulations you have completed the required steps to create a global,
exciting and factual Asset Posting on the Asset Marketing Network for the
world to view.
You have achieved your goal in establishing a Commission and Fee
Free Asset Posting which will lead to a win/win transaction!!!!
The Asset Marketing Member Network has provided all the necessary
tools, links and professionalism which assisted you in this process.
It is now up to you, after doing the hard work, to be able to enter into
negotiations with a Qualified Asset Buying Member.
It is suggested that you follow the link to, “The Art of Negotiating” and
similar sites, as the final step in this process.

TABLE 4
Property Posting Master Check List

```
Review the professional inspection report, provided that an inspection
was completed, prior to Posting.
Get expert advice and pricing for each problem that is sited in the report.
Then a determination can be made to either correct or not to correct
the problems.
This can be used as a negotiating tool.
Complete a cosmetic review of the interior.
Pay particular attention to cleanliness, clutter, paint, stains or leaks.
It may be necessary to remove items, paint, clean carpeting etc.
Complete a thorough cosmetic structural inspection of the exterior. Correct
where necessary. Curb appeal.
Complete a thorough cosmetic inspection of the property and any
external structures.
Correct where necessary.
Landscaping is important.
Trim and prune shrubs and trees.
Plant flowers as color is a key. Curb Appeal!
The Buying Member will inspect!
Termite and mold inspection!
If discovered, correct prior to activating the Posting.
Home Owners Association (HOA)
If applicable be certain that you have all Documents and Financials for the
  Buying Members review, Including
    Management Company
    Address
    Telephone number
    Fax number
    email address
```

TABLE 5
Types of Property Postings

```
Residential Properties
By Country, State, County, Township, City, Zip Code, Subdivision, Street
    Personal Residences
    Golf
    Tennis
    Equestrian
    Skiing
    Beach
    Island
    Ranch
    Lake
    Mountain
    River
Residential Condominium
By Country, State, County, Township, City, Zip Code, Subdivision, Street
    Personal Residences
    Golf
    Tennis
    Equestrian
    Skiing
    Beach
    Island
    Ranch
    Lake
    Mountain
    River
Residential Patio Homes
By Country, State, County, Township, City, Zip Code, Subdivision, Street
    Personal Residences
    Golf
    Tennis
    Equestrian
    Skiing
    Beach
    Island
    Ranch
    Lake
    Mountain
    River
Residential rentals and leasing by Type:
By Country, State, County, Township, City, Zip Code, Subdivision, Street
    Location
    Size
    Price
Residential Land for Development
By Country, State, County, Township, City, Zip Code, Subdivision, Street
    Personal Residences
    Golf
    Tennis
    Equestrian
    Skiing
    Beach
    Island
    Ranches
    Farms
    Lake
    Mountain
    River
Luxury Property For Sale by Type:
By Country, State, County, Township, City, Zip Code, Subdivision Street
    Personal Residences
    Golf
    Tennis
    Equestrian
    Skiing
    Beach
    Island
    Ranch
    Lake
    Mountain
    River
    Tenants in Common:
  Equally shared ownership
    Foreign
Luxury properties International:
By Country, State, County, Township, City, Zip Code, Subdivision Street
and specific locations
      For Sale
    For Rent
    Personal Residences
    Golf
    Tennis
    Equestrian
    Skiing
    Beach
    Island
    Ranch
    Lake
    Mountain
    River
Luxury Island Properties:
By Country, State, County, Township, City, Zip Code, Subdivision, Street
and Type
    Global
    For Sale
    For Rent
    Personal Residences
    Golf
    Tennis
    Equestrian
    Skiing
    Beach
    Island
    Ranch
    Lake
    Mountain
    River
Water Front properties
By State, County, Township, City, Zip Code, Subdivision, Street
    Personal Residences
    Golf
    Tennis
    Equestrian
    Beach
    Lake
    River
Ocean front properties
By State, County, Township, City, Zip Code, Subdivision, Street
    Personal Residences
    Golf
    Tennis
    Equestrian
    Beach
    Island
Lake Front Properties
By State, County, Township, City, Zip Code, Subdivision, Street
    Golf
    Tennis
    Equestrian
    Skiing
    Beach
    Island
    Mountain
River Front Properties
By State, County, Township, City, Zip Code, Subdivision, Street
    Golf
    Tennis
    Mountain
    Equestrian
Vacation Properties Rental by Type:
By State, County, Township, City, Zip Code, Subdivision, Street
    Golf
    Tennis
    Skiing
    Equestrian
    Beach
    Mountain
    Ranch
    River
Vacation Property For Sale by Type:
By State, County, Township, City, Zip Code, Subdivision, Street
    Golf
    Tennis
    Skiing
    Equestrian
    Beach
    Lake
    Island
    River
    Mountain
    Ranch
Vacation and Property Exchange: one week to one year
Time Share Properties For Sale by Type:
By State, County, Township, City, Zip Code, Subdivision, Street
    Golf
    Tennis
    Skiing
    Equestrian
    Beach
    Island
    Ranch
    Lake
    Mountain
    River
Fractional Properties For Sale by Type
By State, County, Township, City, Zip Code, Subdivision, Street
    Golf
    Tennis
    Skiing
    Equestrian
    Beach
    Island
    Ranch
    Lake
    Mountain
    River
Fractional Properties For Rent by Type
By State, County, Township, City, Zip Code, Subdivision, Street
    Golf
    Tennis
    Skiing
    Equestrian
    Beach
    Island
    Ranch
    Lake
    Mountain
    River
Commercial Land for Development
By State, County, Township, City, Zip Code, Subdivision Street
    Strip and Neighborhood Shopping Centers
  Malls
    Office Condominiums
    Freestanding buildings.
    Apartment Complexes
    Office Buildings
    Warehouses
    Mini Storage, Of [symbol]   ce
    Warehouse
    Mobile Home Parks
    Campgrounds
    Transfer Stations
Investment Properties:
By State, County, Township, City, Zip Code, Subdivision, Street
    Strip and Neighborhood Shopping Centers
  Malls
    Free standing buildings.
    Apartment Complexes
    Office Complexes-Parks
    Office Buildings
    Warehouses
    Mini Storage, Office
    Warehouse
    Mobile Home Parks
    Campgrounds
    Transfer Stations
    Triple net Leases
    Ranches
    Farms
    Mines
    Logging
    Fisheries
    Water Projects
    Vineyards
Land and Natural Resource Properties
By State, County, Township, City, Zip Code, Subdivision, Street
    Ranches
    Farms
    Mines
    Logging
    Fisheries
```

Any member of the asset marketing network is able to search the database of assets posted for sale through the asset marketing network website. Method 200 of conducting an asset marketing network business according to the invention as shown in FIG. 2 includes step 164, allowing the asset buying member to use an asset search utility of the asset marketing network website to search the asset database. Step 164 is included in step 160 of method 100 of FIG. 1. Asset buying members will be allowed to use different utilities which will facilitate a sale according to the type of asset they are wishing to buy. Continuing the real estate transaction example, an asset marketing network asset buying member who wished to purchase a real property would follow the steps outlined by the asset marketing network property buying process, as shown in Table 6. The asset buying member wishing to purchase a real property would be provided with the Property Buying Master Checklist as shown in Table 7. The asset marketing network property buying process outlined in Table 6 shows that the asset buying member would be led through the process of searching for and finding a real property that they are interested in purchasing. The asset buying member would be led through the process of becoming pre-qualified, which might include getting a credit score, finding a lender, obtaining a lender pre-approval, or obtaining proof of funds. All the necessary and useful links, documents, and steps will be outlined to the asset buying member on the asset marketing network website. Once the asset buying member is pre-qualified, the asset buying member can be connected to the asset posting member of the asset that is of interest so that the asset buying member can personally inspect and determine if the transaction will continue. In some embodiments of the invention this step will not occur until both the asset buying member and the asset posting member agree to release further controlled asset posting or prequalification information.

In some embodiments the microprocessor hosting the website according to the invention us configures to perform the step of calculating a current market value for an asset. In some embodiments the microprocessor is configured to perform the step of providing to the asset posting member, via the website, the amount of fund a specific asset buying member can finance, upon approval to release this information from the asset buying member. In some embodiments the microprocessor is configured to calculate the amount of funds the specific asset buying member can finance, and provide the asset posting member the amount of funds the specific asset buying member can finance, in response to receiving the request from the specific asset buying member for access to the set of controlled asset posting data pertaining to the asset posted by the asset posting member. In some embodiments the microprocessor is configured to perform the step of providing to the specific asset buying member, via the website, a set of asset purchase forms customized to follow laws governing the sale of the asset.

Step 166 of method 200 of conducting an asset marketing network business according to the invention includes transferring controlled asset posting information between the asset buying member and the asset posting member in response to receiving an approval from both the asset buying member and the asset posting member to transfer the controlled asset posting information, as shown in FIG. 4. Step 166 is a part of step 160 of method 100 of FIG. 1. Once the asset buying member is pre-qualified, and the asset posting member approves, the asset buying member is given the address and/or other controlled information so that an inspection of the property can occur. In some embodiments this information transfer does not occur until the asset posting member is provided prequalification data from the asset buying member.

If the asset buying member wishes to continue the purchase transaction process after an inspection, the asset marketing network website will guide the asset buying member through the process of bidding and negotiating the sale. All contracts, forms, offer letters, and other items which are necessary or helpful are provided to the asset buying member by the asset marketing network website utilities. Once an offer is accepted, the asset buying member and the asset posting member are guided through the sale process. Links to title companies, escrow agents, and lending institutions are provided by the asset marketing network website utilities. The asset posting member and the asset buying member are guided through the closing process and the purchase becomes final.

TABLE 6
Property Buying Process

```
The prospective Asset Buying Member visits the Asset Marketing
Network Website and becomes informed about the features and benefits
offered by becoming an Asset Marketing Network Member.
At this time the prospective Asset Buying Member may select the option
to join or not.
If so:
An Icon appears: Click it and proceed to join.
An Icon appears: Click it
At this time the Member completes the informational application.
Then is issued a Discrete Identification Number and creates a password,
which is used for all Network communication purposes.
All secure and private communications are completed through the use of
these the secure ID numbers.
Note: We recommend that a sincere Buying Member be pro-active as
time is of the essence in Real Estate.
After joining the Network members may then begin the viewing process.
Member selects the view property Icon:
Click it To begin searching the asset database.
Select specific locations:
Country
State
County
Parish
City
Zip code
Township
Subdivision
Street
School District
Select Property Type:
Residential Green Properties
Residential Properties
Residential 2-Plex
Residential 4-PLex
Residential Condominiums
Residential Gated Community Properties
Residential Luxury Properties
Residential Adult Communities
Residential Senior Citizen Communities
Residential Golf Communities
Residential Golf Properties
Residential Waterfront Properties
Residential Ski Properties
Residential Tennis Properties
Residential and Investment Equestrian Properties
Residential Ocean Front Properties
Residential Vacations Properties
Residential Rental Properties
Click done and an icon appears:
Then the Select Options Form appears:
Enter the Price Range in the appropriate boxes
Select Residence Style: or click all.
    Colonial
    Contemporary
    Santa Barbara
    Desert Style
    Tudor
    Cotswald
    Santa Fe
    Country French
    English Manor
    Cape Cod
    Colonial Cape
  Ranch
    To be expanded
    Square Footage
    Lot Size
    Number of bedrooms
    Number of Baths
    Number of levels
    Numbers of Fireplaces
    Number of Garages
    Wine room
    Exercise room
    Family room
    Great room
    Office
    Walk in closets
    Pool outdoor
    Pool indoor
    Spa out door
    Spa indoor
    Sauna
    Steam bath
    Casita
    Guest House
    Carriage House
    R V access and storage
    Handicap accessible
    Exterior storage
    Sub-division
    School District
    Community type
    Year Built
    Type of construction
    Gated Community
    Security system
    After the Buying Member selects all the options they now click:
    “The Find my new Home Icon”
  The Network searches the asset database and sends to the Asset
  Buying Member's computer the asset posting information pertaining
  to properties that meet their search criteria
  Investment and Specific Use Properties
  Farm and Ranch Properties:
Natural Resource Properties
Commercial Properties
Manufacturing Properties
Industrial Properties
Multi-Family Properties
Investment Properties
Check the appropriate box
An Icon appears: Click it.
Click and the search begins
Asset Buying Member searches the Network for properties.
Asset Buying Members identify properties in which they have interest.
Asset Buying Member select the ID numbers for those properties which
are then posted to their secure ID numbered account.
The Asset Buying Member has received these postings and starts the
review process. They read the postings.
View photos and videos
Use Google Earth
Click save to my secure ID numbered folder each posting of interest.
Repeat this step for each property of interest.
The Asset Buying Member can change the search criteria at anytime.
Logic dictates that different criteria be inputted for new searches.
All property viewings are accomplished via secure e-mail through the use
of the secure Member ID.
Actual addresses are not supplied only zip codes are allowed at this time.
This protects the security and privacy of both Members.
All communications are initiated by the secure ID number. These actions
protect the security and privacy of both Members.
The Asset Buying Member should use the links and informational search
tools the Network provides to satisfy the Buying Members due diligence
requirements for their selected Postings. Such as:
Schools
Transportation
Religious requirements
Recreational facilities
and any other criteria of importance to the Buying Member.
If the Buying Member has specific questions about a Posting an email
may be sent to the Network using the secure ID.
An email reply will be sent with the answers.
Click done:
The Asset Buying Member can now obtain pre-qualification data
Check My Credit Score Appears:
Various Member Credit Agencies pop up for the Buying Members use.
It is important to know your FICO score.
A link to various sites will be available to check your FICO score.
Click done
An Icon appears: click it
It is a recommendation that the Asset Buying Member complete a loan
pre-approval application.
This Application can then be forwarded to a Member Lender or to
Lenders of your choice. This information is not retained by the Network!
Use of the Network approved lenders is recommended.
The Network will forward the application to the selected Lenders.
If additional information is required the Lender will contact the
Member directly.
Upon approval electronically send the pre-approval letter to the
Network. The Buying Member can request the Lender to forward the
pre-approval electronically to the Network using the secure ID number
If it is an all cash transaction, a letter of proof of funds equal to or greater
than the posting price is required from a financial institution or
brokerage company.
Forwarded electronically to the Network.
It is a requirement that all Buying Members be pre-qualified to tour any
posted residential property.
Should you choose to tour a property, this will allow the process to
speed along. This protocol is a requirement to view any residential
Posting.
This is not a requirement to view properties on the Network.
Click done
An Icon appears: Click it
The Networks principal and interest calculator pops up for the Members
use.
This process will help to determine how much the member can afford
to pay monthly, including Principle, Interest, Real Estate Taxes, Insurance,
Mortgage Insurance and HOA fees.
This approval and information will be secure and must be provided to
the Network electronically prior to any direct Member to Member contact.
These actions place the Buying Member on “A Clear Path” to a money
saving purchase.
This starts the process towards creation of a purchase contract.
After a successful completion of these simple steps the Network will
notify the Asset Buying Member and the Asset Posting Member, and,
upon approval of both, will release controlled asset posting information
such as street addresses, email addresses. It is a Network recommendation
that all Members utilize the Networks Video Communications for face to
face dialogue. This action will be exceptionally beneficial
to both the asset buying and asset Posting Member.
At this point the asset Buying Member has:
    Joined the Network.
  Searched the Network.
    Viewed and studied the Posting of interest.
  Used the principle and interest calculator.
  Used a Member Credit Agency to verify their credit score.
  Completed a loan pre-approval application.
  Received a notification of pre-approval from the financial institutions.
    The property, email addresses and telephone numbers have been
    released.
Getting the Member organized to view properties and present offers for a
purchase.
The Network recommends that the Asset Buying Member download and
print all the necessary forms and a working folder for each potential
property.
The forms include:
    A standard Real Estate Purchase Contract
    A counter offer form
    A copy of the loan Pre-approval letter.
  A personal check to support the offer. Check will be issued to a Title
  Company, Escrow agent, Attorney. Never make a check out to
  the owner.
  A copy of each Posting printed from the Network.
  Lead Paint disclosure form necessary for home built prior to 1978
    A written request for an Insurance Claims history.
    A swimming pool disclosure form if needed.
  Take a camera to keep a photo record of each property. Do not trust
  your memory.
  Use a copy of the Asset Marketing Network Property Buying Master
  Check list (see Table 7) to accurately follow each step of the
  process for each property to be viewed.
  Now the Buying Member can utilize the Network and make
    appointments for on site visits to their selected postings.
Creating an Offer:
When a property has been selected and an offer is to be presented it must
always be done in writing.
Offers are written using the Standard Real Estate contract in Triplicate.
Be sure to fill every informational box! Initial the bottom of each page
of every document.
The offer is signed by all parties whose name will appear on the Deed
and presented by the Buying Member
This creates a copy for the Buying and Selling Members and also for the
Title Company and/or the Attorney/escrow agent.
If the offer is accepted by the Posting Member and signed by the Posting
Member (all parties) the contract is taken to the Buying Members
Title Company, Attorney or appropriate Escrow Agent all of which
are Licensed, Bonded and Insured.
If an offer is rejected the Contract is not destroyed.
A Counter offer is written with the new price and added information.
If the Counter Offer is accepted and all the documents are signed in
the appropriate places.
Then the completed Documents are taken to the above named agents to
open escrow.
These documents now become a legal instrument and the clock to
closing begins to tick.
Process after obtaining a signed contract:
Complete all the financial needs.
Get the Mortgage and Insurance in place
Get a copy of the Title report as soon as possible and review!
The inspection period, usually 10 days, begins after the Contract is signed.
A complex home may require as much as 30 days.
These dates are always written in the Contract.
Always use a certified Home Inspection Company!
Always use a certified Termite Inspector!
Always use a Certified Engineer!
Review all the reports in detail.
Get a Professional Contractor to submit estimates of the cost to correct
faults in writing.
The Posting Member may request a copy of the inspection reports so that
they can make repairs or compensate the Buying Member.
If repairs are completed get copies of the invoices and if necessary have
the repairs inspected.
The appropriate form should be used, signed by all parties and attached
to the Contract.
This may effect another Counter offer to compensate for the repairs.
Submit a notice to cure to the Posting member.
The Posting member has 3 days to cure any faults or make a counter
offer in kind
After the faults are corrected or compensated for and the inspection
period is done.
All changes made to the Original Contract must be in writing using the
correct Network forms and signed by all parties and attached to
the Original Contract!
At this point the Contract goes hard!
The time to close escrow is of essence!
It is recommended that both Members log on using the secure ID's
provided and transfer all the information to their ID protected account
for safekeeping, updating and referral.
The Closing Process, What to expect?
At a Title Company closing the normal process is:
The Posting Member normally signs all the closing documents 2-3 days
prior to the closing date.
The Titles Company after that updates the Title.
It is normal that the funds to close arrive the day before close of escrow
in Certified Funds.
On the closing date the Buying parties review all the closing documents
and the loan ducuments.
Review the closing statement with the Escrow Officer.
After approving and signing the closing documents.
You own a new home. Congratulations!
What's more you paid no Commissions!
At a closing that is handled by an Attorney the normal process is:
The closing may be held at the Lenders office, the Lenders Attorney's
office, your Attorney's office or at a Title Companies office.
The attendees may be:
    Your Attorney
    The Lenders Attorney
    A Lender's Officer
    The Title Company's Escrow Agent
    A Notary Public
    Asset Buying Member and the Asset Posting Member.
```

TABLE 7
Property Buying Master Checklist

Property Buying Master Check List for Asset Buying Members
Asset Buying Members are urged to use the Master Check List for each
property visited.
Be diligent mark every step.
Take notes and take lots of pictures
Always, always save picture and notes for later review.
Do not trust your memory, you are not that good! You will note that this
will be repeated constantly.
Buying real property is an emotionally exhausting process.
The Network's goal is to make less emotional, logical and to be a financial
success for both Members. Win/Win.
The major benefit of the Network process is that the Posting Member
knows that you are coming and should be prepared.
Your visit is to validate the posted information and your expressed
interest in the property.
Drive or walk around the area. Get a sense of the neighborhood.
Take photos. Take notes.
Inspect the exterior of the property: Land, landscaping, topography,
orientation. Take photos, Take notes.
Inspect the structures exterior: cosmetic condition, roofs, windows,
doors, gutters, storm windows and any items attached to structure.
Take photos. Take notes.
Inspect the interior: Validate the all the posting information for accuracy
and condition.
Take photos. Take notes
Appliances: model numbers, sizes, etc. Make notes on each noting
condition and age.
Take photos. Take notes.
Bathrooms: sinks, toilets, showers, Fixtures, tubs, tile and any specialty
fixtures.
Take photos. Take notes.
Inspect all flooring: wood, carpet, tile, masonry for condition and age.
Take photos. Take notes.
Inspect: heating systems, air conditioning systems, water and sewer
systems. Age and condition. Ask for service records, if available.
Take photos. Take notes.
inspect all documents: Plans, permits, tax bills, utility bills. Ask for
copies.
If you have prepared a list of questions now would be a good time to ask.
If there are any issues that the Member Buyer is unsure. The Network
recommends that Network Professional be consulted.
Takes notes.

It is to be understood that many other types of assets can be bought and sold other than the real estate examples used in this document. The asset marketing network will provide the steps, the resources, the know-how, and the network for successfully posting and selling many different types of assets.

Step 180 of method 100 of FIG. 1 is receiving fees from asset marketing network members. The business owner who is conducting the asset marketing network business according to the invention will be collecting fees from members of the asset marketing network website. These fees will often be less than the fee that a broker charges for facilitating an asset sale. The fee paid to the asset marketing network business owner for a real estate sale will be less than real estate brokers charge. The business owner will be able to collect many more of these fees, however, because the asset marketing network website will be providing the services to a worldwide network of members. The volume of sales will be high, and the personal interaction needed by the asset marketing network business owner will be low, allowing the asset marketing network business owner to make a living from a high volume of lower fees, instead of a lower volume of higher fees.

Step 182 of method 200 of conducting an asset marketing network business according to the invention is receiving an asset purchase fee in response to the asset buying member purchasing the asset, as shown in FIG. 4. Step 182 of method 200 is a part of step 180 of method 100. Once a sale of a real property, or any asset sold using the asset marketing network is completed, the owner of the asset marketing network business will receive a success fee. This is one type of fee that the business owner will receive.

The owner of the asset marketing network business will be collecting fees from various asset marketing network members. In some embodiments the asset marketing network business owner will be receiving fees for allowing a business to advertise on the asset marketing network website. In some embodiments the asset marketing network business owner will be receiving fees from vendors whose services are offered to asset marketing network members on the asset marketing network website. The asset marketing network website will be connecting many different types of members within the network, and the asset marketing network business owner will be collecting fees from a portion of the asset marketing network members for being able to participate in the asset marketing network.

As described earlier, machine 110 of FIG. 2 and FIG. 3 is used to conduct an asset marketing network business according to the invention. Machine 110 including microprocessor 116, memory 112, and software program 114 are used to host the asset marketing network website. Software program 114 instructs microprocessor 116 to conduct the various steps involved in hosting the asset marketing network website on the internet, registering asset marketing network members, and providing asset marketing network members with access to the information and utilities that they are given as members of the asset marketing network. Machine 110 can be a part of any device which allows machine 110 to be accessed by members via the internet or an internet-like connection.

In the embodiment shown in FIG. 3, machine 110 is resident on server 118 and is accessed by user interface devices 124 via internet connection 122. FIG. 3 shows one user interface device 124 connected to machine 110 via internet connection 122, but it is to be understood that many user interface device 124 can be connected to the asset marketing network website hosted by machine 110 at any one time. It is to be understood that internet connection 122 is capable of connecting asset marketing network members worldwide to the asset marketing network website that is hosted by machine 110. And it is to be understood that any type of user interface device 124 can be used to access the asset marketing network website, including but not limited to, laptops, smartphones, portable digital assistants, portable computers, smart phones, computerized tablets, communication devices, fixed computerized devices, mobile computerized devices, or any other device that is capable of interfacing with a website. It is to be understood that connection 122 can be any type of communications interface, wired or wireless, that allows a user interface device 124 to interface with a website hosted by machine 110.

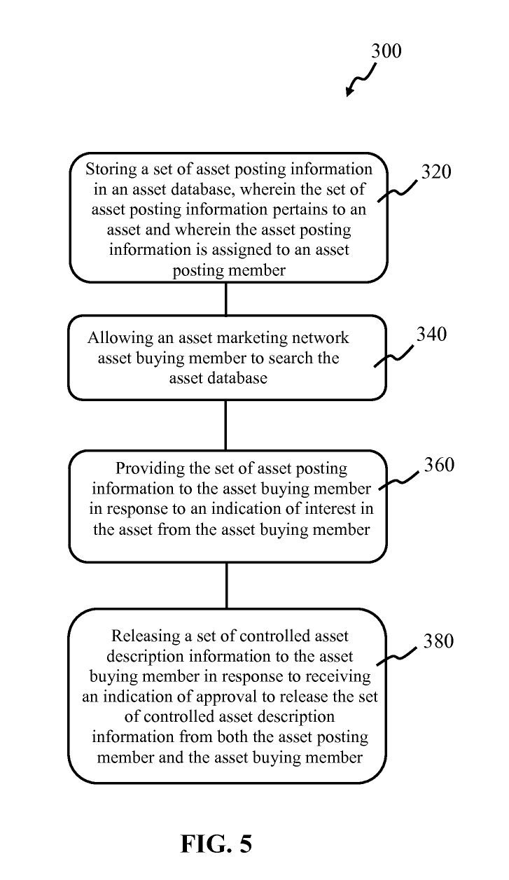

FIG. 5 shows one embodiment of set of steps 300 which machine 110 performs in support of conducting the asset marketing network business according to the invention. Machine 110 includes memory 112 coupled to microprocessor 116. Memory 112 has software program 114 stored on it. Software program 114 instructs microprocessor 116 to perform set of steps 300 according to the invention as shown in FIG. 5. In this embodiment set of steps 300 includes step 320 storing a set of asset posting information in an asset database, wherein the set of asset posting information pertains to an asset and wherein the asset posting information is assigned to an asset posting member. Step of steps 300 also includes step 340 allowing an asset marketing network asset buying member to search the asset database. In some embodiments this search is done via the asset marketing website. Set of steps 300 also includes step 360, providing the set of asset posting information to the asset buying member in response to an indication of interest in the asset from the asset buying member, as shown in FIG. 5. And in this embodiment set of steps 300 includes step 380 releasing a set of controlled asset description information to the asset buying member in response to receiving an indication of approval to release the set of controlled asset description information from both the asset posting member and the asset buying member. Set of steps 300 according to the invention can include many other steps.

Step 320 of set of steps 300 in the embodiment shown in FIG. 5 is the step of storing a set of asset posting information or data in an asset database, wherein the set of asset posting information pertains to an asset and wherein the asset posting information is assigned to an asset posting member. In this step machine 110 is storing the set of asset posting information that the asset buying member has compiled as explained above and in Table 3 with respect to real estate property, for example. The asset marketing network asset posting member uses the links, forms, guidelines, and utilities provided by the asset marketing network website to compile information on the asset they want to sell. In step 320 machine 110 stores this information in an asset database. The asset database can be searched by asset marketing network members that are looking to purchase assets. The set of asset posting information can pertain to any asset. In some embodiments the set of asset posting information pertains to a real property. In some embodiments the set of asset posting information pertains to a form of real estate. In some embodiments the set of asset posting information pertains to a business. In some embodiments the set of asset posting information pertains to another type of high-value asset. The set of asset posting information can pertains to any type of asset that the asset posting member wishes to sell using the asset marketing network.

The set of asset posting information pertains to an asset and is assigned to the asset posting member which provided the set of asset posting information. Machine 110 tracks which asset posting member has provided each set of asset posting information so that the asset posting member can be sent information on how many hits their set of asset posting information is obtaining, as well as eventually linking a prospective asset buying member to the asset posting member for sale negotiations. In some embodiments step 320 includes the step of storing the set of asset posting information according to a taxonomy of asset data. In some embodiments step 320 includes storing the set of asset posting information such that the information can be searched. Step 320 of set of steps 300 can include many other steps.

Step 340 allowing an asset marketing network asset buying member to search the asset database includes any steps software program 114 instructs microprocessor 116 to perform to allow a registered asset marketing network member to search the asset database for available assets. In some embodiments step 340 includes verifying asset marketing network membership. In some embodiments step 340 includes accepting search terms. In some embodiments step 340 includes applying search terms to conduct a search of the asset database. In some embodiments step 340 includes using search terms to search the asset database. In some embodiments step 340 includes presenting search results to the asset marketing network asset buying member. Step 340 includes those steps involved in allowing an asset buying member to search the asset database and identifying one or more than one set of asset posting information which describes an asset that the asset buying member might be interested in purchasing.

Step 360 of set of steps 300 according to the invention is the step of providing the set of asset posting information to the asset buying member in response to an indication of interest in the asset from the asset buying member. In some embodiments of step 360 the asset buying member who has conducted a search of the asset database is provided a list of the sets of asset posting information which might describe assets which they are interested in based on their search terms. The asset buying member can review the list of sets of information pertaining to assets and indicate which one they are interested in receiving the complete set of asset posting information for. The asset buying member can indicate their interested via a click, entering a checkmark, or any other user response recognizable by machine 110. Machine 110 responds to the indication of interest in the asset described by a set of asset posting information from the asset buying member by providing the set of asset posting information to the asset buying member. The asset buying member can now peruse the set of asset posting information and determine if they are interested in the asset enough to continue the asset inspection and possible purchase process.

Step 380 of set of steps 300 according to the invention is the step of releasing a set of controlled asset posting information to the asset buying member in response to receiving an indication of approval to release the set of controlled asset posting information from both the asset posting member and the asset buying member. In some situations it is not desirable to have all of the information regarding a particular asset being released to every asset buying member who indicates initial interest. In a real estate transaction, for instance, the asset posting member who is wanting to sell a real property may not want to release the address of the property to an asset buying member who shows initial interest. The asset posting member may want to require further actions to be taken by the asset buying member to prove that they are serious and qualified to buy the property before the address information is released. This information—a set of controlled asset description/posting information—can be kept confidential by machine 110 until an indication is received from both the asset buying member and the asset posting member that the set of controlled asset posting information pertaining to an asset is to be released to the asset buying member. In the example of the real property, the asset posting member may want to be provided with a pre-qualification form from a lender that proves that the asset buying member is monetarily qualified to purchase the property. Other specific asset may have other pre-qualification terms attached to them that the asset buying member must satisfy before the set of controlled asset description information is released to the asset buying member. This allows the asset posting member to minimize the number of non-serious members taking up the time and effort of the asset posting member. Once software program 114 receives an indication from both the asset buying member and the asset posting member of their approval for releasing the set of controlled asset description information to the asset buying member, then the set of controlled asset description information will be released by machine 110 to the asset buying member for further action.

Set of steps 300 can include many other steps. Set of steps 300 can include any step software program 114 instructs microprocessor 116 to perform related to hosting the asset marketing network website and conducting the asset marketing network business according to the invention.

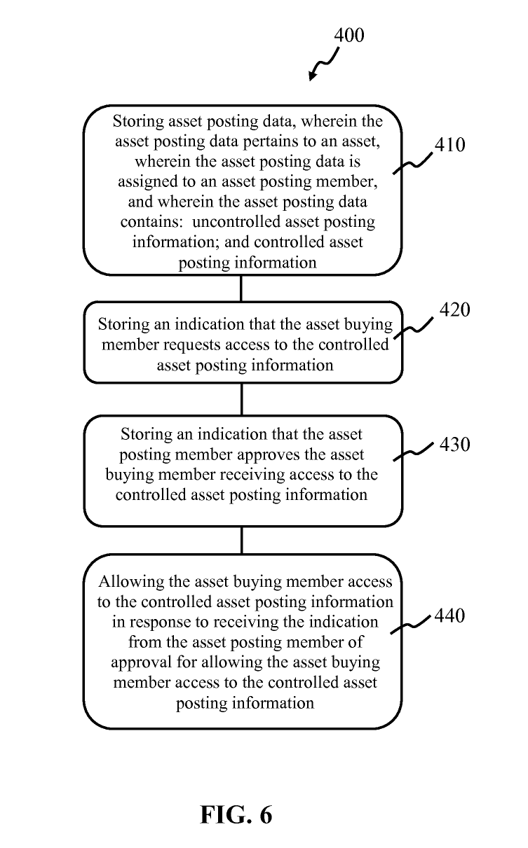

Disclosed is a machine for conducting an asset marketing network business. The machine includes a microprocessor coupled to a memory configured to perform a number of steps. FIG. 6 illustrates steps 400 the microprocessor is configured to perform. The steps the microprocessor is configured to perform includes step 410 of storing asset posting data, wherein the asset posting data pertains to an asset, wherein the asset posting data is assigned to an asset posting member, and wherein the asset posting data includes uncontrolled asset posting information and controlled asset posting information. Set of steps 400 the microprocessor is configured to perform also includes step 420 of storing an indication that the asset buying member requests access to the controlled asset posting information. Set of steps 400 the microprocessor is configured to perform also includes step 430 of storing an indication that the asset posting member approves the asset buying member receiving access to the controlled asset posting information. And set of steps 400 the microprocessor is configured to perform includes step 440 of allowing the asset buying member access to the controlled asset posting information in response to receiving the indication from the asset posting member of approval for allowing the asset buying member access to the controlled asset posting information. Set of steps 400 can include many other steps.

In some embodiments set of steps 400 the microprocessor is configured to perform includes the step of calculating a current market value for the asset. In some embodiments the step of calculating a current market value for the asset comprises the step of storing a property address for the asset. In some embodiments the step of calculating a current market value for the asset comprises the step of searching the internet to find sales data for a set of similar properties in a predetermined geographical area near the asset. In some embodiments the step of calculating a current market value for the asset comprises the step of storing a property condition rating for the asset. In some embodiments the step of calculating a current market value for the asset comprises the step of calculating a current market value for the asset, based on the property condition rating and the sales data for the set of similar properties in the predetermined geographical area near the asset.

In some embodiments set of steps 400 the microprocessor coupled to the memory is configured to perform includes the steps of storing prequalification data associated with the asset buying member, and restricting the asset posting member from accessing the prequalification data. In some embodiments set of steps 400 the microprocessor coupled to the memory is configured to perform includes the step of storing an indication that the asset posting member requests access to the prequalification data. In some embodiments set of steps 400 the microprocessor coupled to the memory is configured to perform includes the step of storing an indication that the asset buying member approves of the asset posting member receiving access to the prequalification data. In some embodiments set of steps 400 the microprocessor coupled to the memory is configured to perform includes the step of allowing the asset posting member access to the prequalification data in response to receiving the indication that the asset buying member approves of the asset posting member receiving access to the prequalification data. In some embodiments the prequalification data comprises a prequalification statement from a lender. In some embodiments the prequalification data comprises a statement of sufficient funds from a bank.

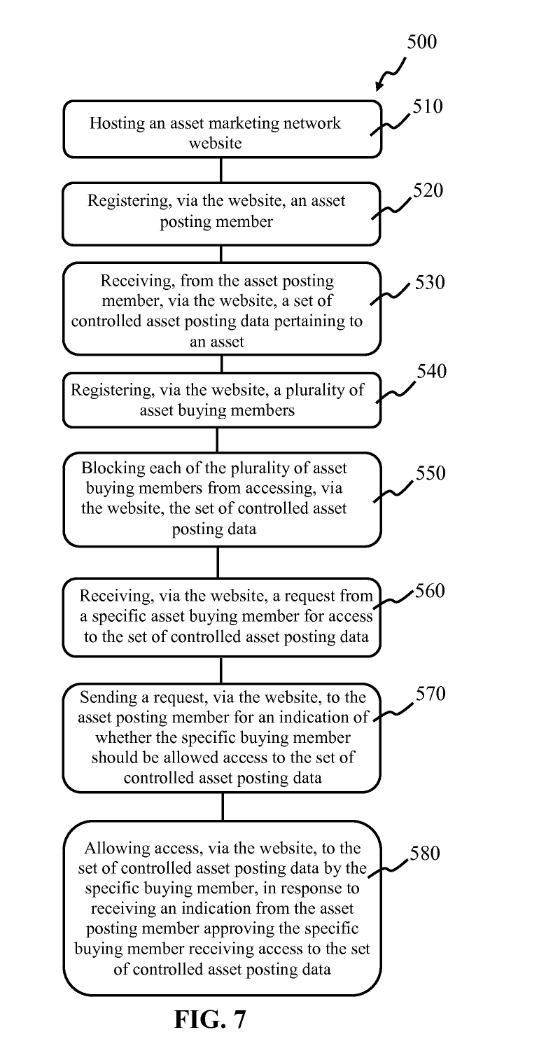

Disclosed is a microprocessor coupled to a memory configured to perform set of steps 500 as shown in FIG. 7. Set of steps 500 includes step 510 of hosting an asset marketing network website, step 520 registering, via the website, an asset posting member, step 530 of receiving from the asset posting member, via the website, a set of controlled asset posting data pertaining to an asset, and step 540 registering, via the website, a plurality of asset buying members. Set of steps 500 the microprocessor coupled to a memory is configured to perform also includes steps 550 of blocking each of the plurality of asset buying members from accessing, via the website, the set of controlled asset posting data, step 560 receiving, via the website, a request from a specific asset buying member for access to the set of controlled asset posting data, step 570 of sending a request, via the website, to the asset posting member for an indication of whether the specific buying member should be allowed access to the set of controlled asset posting data, and step 580 of allowing access, via the website, to the set of controlled asset posting data by the specific buying member in response to receiving an indication from the asset posting member approving the specific buying member receiving access to the set of controlled asset posting data.

Set of steps 500 can include many other steps. In some embodiments set of steps 500 the microprocessor is configured to perform includes the step of calculating a current market value for the asset. In some embodiments set of steps 500 the microprocessor is configured to perform includes the step of calculating an amount of funds the specific asset buying member can finance. In some embodiments set of steps 500 the microprocessor is configured to perform includes the step of providing to the asset posting member, via the website, the amount of funds the specific asset buying member can finance. In some embodiments set of steps 500 the microprocessor is configured to perform includes the step of providing to the specific buying member, via the website, a set of asset purchase forms customized to follow laws governing the sale of the asset.

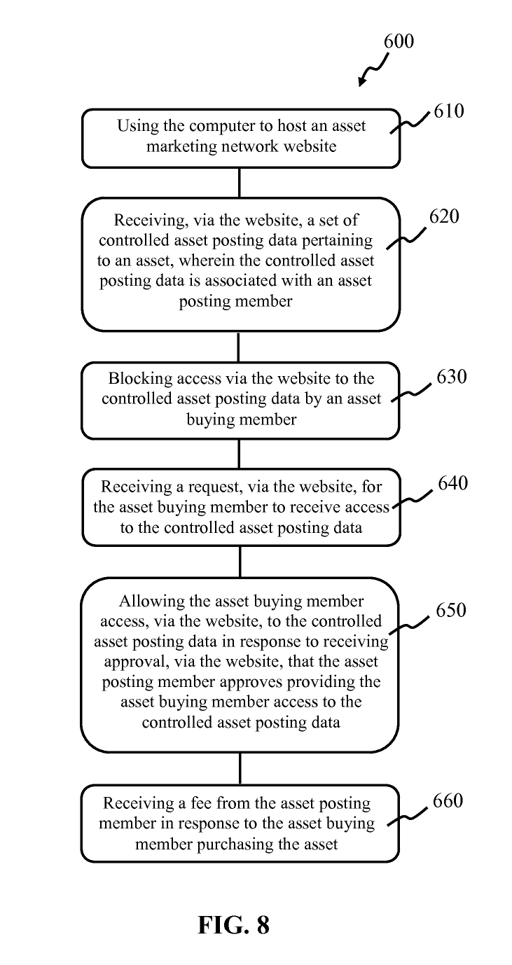

Disclosed is computer performed method 600 of conducting an asset marketing network website business, as shown in FIG. 8. Computer performed method 600 of conducting an asset marketing network business includes step 610 of using the computer to host an asset marketing network website, and step 620 of receiving, via the website, a set of controlled asset posting data pertaining to an asset, wherein the controlled asset posting data is associated with an asset posting member. Computer performed method 600 of conducting an asset marketing network business also includes step 630 of blocking access via the website to the controlled asset posting data by an asset buying member, and step 640 receiving a request, via the website, for the asset buying member to receive access to the controlled asset posting data. Computer performed method 600 of conducting an asset marketing network business also includes step 650 of allowing the asset buying member access, via the website, to the controlled asset posting data in response to receiving approval, via the website, that the asset posting member approves providing the asset buying member access to the controlled asset posting data, and step 660 of receiving a fee from the asset posting member in response to the asset buying member purchasing the asset.

Method 600 of conducting an asset marketing network website business can include many other steps. In some embodiments the method also includes the steps of registering an asset posting member, where the asset posting member is allowed access to the asset marketing network website, and registering an asset buying member, wherein the asset buying member is allowed access to the asset marketing network website. In some embodiments method 600 also includes the steps of receiving, via the website, a set of uncontrolled asset posting data from the asset posting member, where the set of uncontrolled asset posting data pertains to the asset, the step of storing the set of uncontrolled asset posting data in a database, and the step of allowing the asset buying member access, via the website, to the set of uncontrolled asset posting data. In some embodiments the step of receiving, via the website, a set of uncontrolled asset posting data from the asset posting member includes the steps of computing a current market value for the asset; providing, via the website, a list of asset inspectors; and providing, via the website, a list of asset appraisers. In some embodiments the step of receiving, via the website, a set of uncontrolled asset posting data from the asset posting member includes the steps of providing, via the website, a list of vendors of advertising services, and receiving from the asset posting member, via the website, an advertisement for the asset.

In some embodiments method 600 includes the steps of receiving, via the website, a set of prequalifying data from the asset buying member, the step of allowing web access to the set of prequalifying data by the asset posting member in response to receiving a request, via the website, that the asset buying member requests access to the controlled asset posting data, and the step of receiving approval, via the website, that the asset posting member approves of providing the asset buying member access to the set of controlled asset posting data. In some embodiments the step of receiving, via the website, a set of prequalifying data from the asset buying member includes the steps of providing to the asset buying member, via the website, a listing of lending institutions, the step of computing a monthly payment amount, the step of providing to the asset buying member, via the website, a set of prequalification forms, and the step of receiving, via the website, the set of prequalifying data from the asset buying member.

The embodiments and examples set forth herein were presented in order to best explain the present invention and its practical application and to thereby enable those of ordinary skill to use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above. Appendix A attached to this document provides additional details, embodiments and information on the asset marketing network business method according to the invention.

1. A machine for conducting an asset marketing network business, the machine comprising:
a microprocessor coupled to a memory configured to perform the following steps:
storing asset posting data, wherein the asset posting data pertains to an asset, wherein the asset posting data is assigned to an asset posting member, and wherein the asset posting data comprises:
uncontrolled asset posting information; and
controlled asset posting information;
storing an indication that the asset buying member requests access to the controlled asset posting information;
storing an indication that the asset posting member approves the asset buying member receiving access to the controlled asset posting information; and
allowing the asset buying member access to the controlled asset posting information in response to receiving the indication from the asset posting member of approval for allowing the asset buying member access to the controlled asset posting information.

2. The machine of claim 1, wherein the microprocessor coupled to the memory is further configured to perform the step of calculating a current market value for the asset.

3. The machine of claim 2, wherein the step of calculating a current market value for the asset comprises the steps of:
storing a property address for the asset;
searching the internet to find sales data for a set of similar properties in a predetermined geographical area near the asset;
storing a property condition rating for the asset; and
calculating a current market value for the asset, based on the property condition rating and the sales data for the set of similar properties in the predetermined geographical area near the asset.

4. The machine of claim 3, wherein the microprocessor coupled to the memory is further configured to perform the steps of:
storing prequalification data associated with the asset buying member; and
restricting the asset posting member from accessing the prequalification data.

5. The machine of claim 4, wherein the microprocessor coupled to the memory is further configured to perform the steps of:
storing an indication that the asset posting member requests access to the prequalification data;
storing an indication that the asset buying member approves of the asset posting member receiving access to the prequalification data; and
allowing the asset posting member access to the prequalification data in response to receiving the indication that the asset buying member approves of the asset posting member receiving access to the prequalification data.

6. The machine of claim 5, wherein the prequalification data comprises a prequalification statement from a lender.

7. The machine of claim 5, wherein the prequalification data comprises a statement of sufficient funds from a bank.

8. A microprocessor coupled to a memory configured to perform the following steps:
hosting an asset marketing network website;
registering, via the website, an asset posting member;
receiving from the asset posting member, via the website, a set of controlled asset posting data pertaining to an asset;
registering, via the website, a plurality of asset buying members;
blocking each of the plurality of asset buying members from accessing, via the website, the set of controlled asset posting data;
receiving, via the website, a request from a specific asset buying member for access to the set of controlled asset posting data;
sending a request, via the website, to the asset posting member for an indication of whether the specific buying member should be allowed access to the set of controlled asset posting data;
allowing access, via the website, to the set of controlled asset posting data by the specific buying member in response to receiving an indication from the asset posting member approving the specific buying member receiving access to the set of controlled asset posting data.

9. The microprocessor of claim 8, wherein the microprocessor is configured to perform the step of calculating a current market value for the asset.

10. The microprocessor of claim 8, wherein the microprocessor is configured to perform the step of calculating an amount of funds the specific asset buying member can finance.

11. The microprocessor of claim 10, wherein the microprocessor is configured to perform the step of providing to the asset posting member, via the website, the amount of funds the specific asset buying member can finance.

12. The microprocessor of claim 11, wherein the microprocessor is configured to calculate the amount of funds the specific asset buying member can finance, and provide the asset posting member the amount of funds the specific asset buying member can finance, in response to receiving the request from the specific asset buying member for access to the set of controlled asset posting data.

13. The microprocessor of claim 8, wherein the microprocessor is configured to perform the step of providing to the specific asset buying member, via the website, a set of asset purchase forms customized to follow laws governing the sale of the asset.

14. The microprocessor of claim 8, wherein the microprocessor is configured to perform the step of electronically delivering the set of asset purchase forms to a government agency.

15. A computer performed method of conducting an asset marketing network website business, wherein the method comprises the steps of:
using the computer to host an asset marketing network website;
receiving, via the website, a set of controlled asset posting data pertaining to an asset, wherein the controlled asset posting data is associated with an asset posting member;
blocking access via the website to the controlled asset posting data by an asset buying member;
receiving a request, via the website, for the asset buying member to receive access to the controlled asset posting data;
allowing the asset buying member access, via the website, to the controlled asset posting data in response to receiving approval, via the website, that the asset posting member approves providing the asset buying member access to the controlled asset posting data; and
receiving a fee from the asset posting member in response to the asset buying member purchasing the asset.

16. The method of claim 15, further comprising the steps of:
registering an asset posting member, wherein the asset posting member is allowed access to the asset marketing network website;
registering an asset buying member, wherein the asset buying member is allowed access to the asset marketing network website;
receiving, via the website, a set of uncontrolled asset posting data from the asset posting member, wherein the set of uncontrolled asset posting data pertains to the asset;
storing the set of uncontrolled asset posting data in a database; and
allowing the asset buying member access, via the website, to the set of uncontrolled asset posting data.

17. The method of claim 16, wherein receiving, via the website, a set of uncontrolled asset posting data from the asset posting member includes the steps of:
computing a current market value for the asset;
providing, via the website, a list of asset inspectors; and
providing, via the website, a list of asset appraisers.

18. The method of claim 17, wherein receiving, via the website, a set of uncontrolled asset posting data from the asset posting member includes the steps of:
providing, via the website, a list of vendors of advertising services; and
receiving from the asset posting member, via the website, an advertisement for the asset.

19. The method of claim 15, further comprising the steps of:
receiving, via the website, a set of prequalifying data from the asset buying member;
allowing web access to the set of prequalifying data by the asset posting member in response to receiving a request, via the website, that the asset buying member requests access to the controlled asset posting data; and
receiving approval, via the website, that the asset posting member approves of providing the asset buying member access to the set of controlled asset posting data.

20. The method of claim 19, wherein receiving, via the website, a set of prequalifying data from the asset buying member includes the steps of:
providing to the asset buying member, via the website, a listing of lending institutions;
computing a monthly payment amount;
providing to the asset buying member, via the website, a set of prequalification forms; and
receiving, via the website, the set of prequalifying data from the asset buying member.
